(19) United States
(12) Patent Application Publication
(10) Pub. No.: US 2003/0174430 A1
(43) Pub. Date: Sep. 18, 2003

(54) Magnetic disk apparatus

(75) Inventors: Kan Takahashi, Tokyo (JP); Jun Ito, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/376,339

(22) Filed: Mar. 3, 2003

(30) Foreign Application Priority Data
Mar. 13, 2002 (JP) 2002-069139

(51) Int. Cl. G11B 21/02; G11B 27/36

(52) U.S. Cl. 360/75; 360/31

(57) ABSTRACT

A magnetic head includes a slider, and a head portion provided at the slider. The slider and the head respectively have disk opposing surfaces opposite to a surface of a magnetic disk, and the disk opposing surface of the head portion is positioned more apart from the surface of the magnetic disk than the disk opposing surface of the slider. The head portion includes recording and reproducing elements at least partially exposing to the disk opposing surface, and a thermal expanding member arranged in the vicinity of the recording and reproducing elements to thermally expand the disk opposing surface in a direction of approaching the surface of the magnetic disk.

### CROSS-REFERENCE TO RELATED APPLICATIONS

This application is based upon and claims the benefit of priority from the prior Japanese Patent Application No. 2002-069139, filed Mar. 13, 2002, the entire contents of which are incorporated herein by reference.

### BACKGROUND OF THE INVENTION

1. Field of the Invention

The present invention relates to a magnetic disk apparatus.

2. Description of the Related Art

Generally, a magnetic disk apparatus comprises a magnetic disk housed in a case, a spindle motor for supporting and rotating the magnetic disk, a magnetic head for reading/writing information from/to the magnetic disk, and a carriage assembly for supporting the magnetic head to be movable with respect to the magnetic disk. The carriage assembly includes a rotatably supported arm and a suspension extending from the arm. The magnetic head is supported on an extended end of this suspension. The magnetic head has a slider attached to the suspension, and a head portion disposed on the slider. The head portion includes a reproducing element for reading and a recording element for writing.

During an operation of the magnetic disk apparatus, the slider is supported by the suspension in a contact with or a slightly floating over a magnetic recording layer of the rotating magnetic disk. The recording and reproducing elements of the magnetic head are held keeping a desired space, i.e., magnetic spacing between the elements and the magnetic recording layer.

In the magnetic disk apparatus comprising such a floating type or a contact recording type slider, the recording element of the magnetic head generates heat when it records signal on the magnetic disk. Accordingly, parts in the vicinity of the recording and reproducing elements of the magnetic head are thermally expanded toward the side of the magnetic disk. If the amount of this thermal expansion is large, resistance of the reproducing element (MK element) changes by heat generated when the magnetic head projects to come in contact with the surface of the magnetic disk, thus generating an abnormal signal (thermal asperity). When the magnetic head comes in contact with the surface of the magnetic disk, a problem such as uneven wear of the magnetic head also occurs. In recent years, in accordance with higher density of magnetic disks, the floating amount of the magnetic head has become smaller to easily generate thermal asperity.

Therefore, some measures have conventionally been taken to prevent the generation of such thermal asperity. For example, the magnetic head is arranged further apart than the projection amount of the thermally expanded magnetic head from the surface of the magnetic disk, or the floating height of the slider is set large to prevent the parts in the vicinity of the recording and reproducing elements from being brought into contact with the surface of the magnetic disk even when the magnetic head projects.

However, in all of the above-described measures, when there is no thermal expansion of the magnetic head, the space between the recording and reproducing elements and the recording layer of the magnetic disk is large. Consequently, it is difficult to highly accurately reproduce recorded information.

### BRIEF SUMMARY OF THE INVENTION

An embodiment of the present invention may provide a magnetic disk apparatus capable of performing highly accurate recording and reproduction while suppressing generation of thermal asperity.

A magnetic disk apparatus according to an aspect of the present invention comprises a magnetic disk having a magnetic recording layer; a magnetic head including a slider having a disk opposing surface opposite to a surface of the magnetic disk, and a head portion arranged on the slider, the head portion having a disk opposing surface positioned more apart from the surface of the magnetic disk than the disk opposing surface of the slider, recording and reproducing elements at least partially exposing to the disk opposing surface and configured to record and reproduce information on and from the magnetic recording layer of the magnetic disk, and a thermal expanding member arranged in the vicinity of the recording and reproducing elements and configured to thermally expand the disk opposing surface in a direction of approaching the surface of the magnetic disk; a heating element which heats the thermal expanding member; a space detecting unit configured to detect a space between the disk opposing surface of the magnetic head and the surface of the magnetic disk; and a space control unit which adjusts an amount of heat generated from the heating element in accordance with the space detected by the space detecting unit to control the space between the disk opposing surface of the magnetic head and the surface of the magnetic disk to a desired value.

A magnetic disk apparatus according to another aspect of the present invention comprises a magnetic disk having a magnetic recording layer; a magnetic head including a slider having a disk opposing surface opposite to a surface of the magnetic disk, and a head portion arranged on the slider, the head portion having a disk opposing surface positioned more apart from the surface of the magnetic disk than the disk opposing surface of the slider, recording and reproducing elements at least partially exposing to the disk opposing surface and configured to record and reproduce information on and from the magnetic recording layer of the magnetic disk, and a thermal expanding member arranged in the vicinity of the recording and reproducing elements and configured to thermally expand the disk opposing surface in a direction of approaching the surface of the magnetic disk; a heating element which heats the thermal expanding member; and a space control unit which adjusts an amount of heat generated from the heating element in accordance with a temperature in the vicinity of the magnetic head to control the space between the disk opposing surface of the magnetic head and the surface of the magnetic disk to a desired value.

According to the magnetic disk apparatus constituted as described above, the thermal expanding member is expanded in accordance with the space between the disk opposing surface of the head portion and the surface of the magnetic disk, and the recording and reproducing elements can project toward the surface of the magnetic disk to control the space or a magnetic spacing. While adjusting the magnetic spacing, it is possible to suppress generation of abnormal signals or uneven wear caused by contact between the magnetic head and the surface of the magnetic disk.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view of a hard disk drive (hereinafter, referred as an HDD) according to an embodiment of the present invention.

FIG. 2 is an expanded side view showing a magnetic head portion of the HDD.

FIG. 3 is an expanded sectional view showing the magnetic head.

FIG. 4 is a schematic sectional view showing a state where a head portion of the magnetic head is expanded by ambient temperature and heat generated by a recording element.

FIGS. 5A to 5C are schematic sectional views respectively showing a state where first and second thermal expanding members of the magnetic head are expanded, and a state where only one of the thermal expanding members is expanded.

FIG. 6 is a plan view showing an HDD according to another embodiment of the present invention.

FIG. 7 is a plan view showing an HDD according to still another embodiment of the present invention.

### DETAILED DESCRIPTION OF THE INVENTION

Detailed description will be made of an embodiment where a magnetic disk apparatus of the present invention is applied to an HDD.

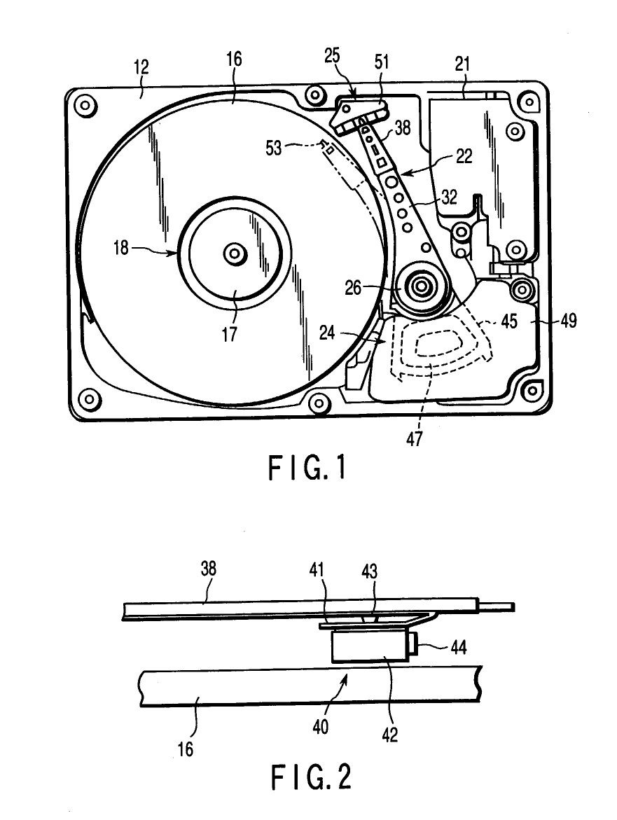

As shown in FIG. 1, an HDD has a rectangular box-shaped case 12 whose upper surface is opened, and a not-shown top cover fixed to the case by a plurality of screws to close the upper end opening of the case.

The case 12 houses two magnetic disks 16 as magnetic recording media (only one is shown), a spindle motor 18 as driving means for supporting and rotating the magnetic disk, a plurality of magnetic heads for writing and reading information to/from the magnetic disk, a carriage assembly 22 supporting each of the magnetic heads to be movable relative to the magnetic disk 16, a voice coil motor (referred to as a VCM hereinafter) 24 for rotating and positioning the carriage assembly, a ramped loading mechanism 25 for holding the magnetic heads in a retreating position away from the magnetic disks when the magnetic heads move to the outermost periphery of each magnetic disk, a substrate unit 21 having a head IC or the like, and the like.

On the outer surface of a bottom wall of the case 12, a printed circuit board (not shown) is fixed by screws to control operations of the spindle motor 18, the VCM 24 and the magnetic heads through the substrate unit 21.

Each magnetic disk 16 has a diameter of 65 mm (2.5 inches), and has magnetic recording layers on the upper and lower surfaces thereof. The two magnetic disks 16 are fitted to an outer periphery of a hub (not shown) of the spindle motor 18, and held by a clamp spring 17. Accordingly, the two magnetic disks 16 are stacked coaxially to each other with a predetermined spacing. By driving the spindle motor 18, the two magnetic disks 16 are integrally rotated at a predetermined speed.

The carriage assembly 22 comprises a bearing unit 26 fixed on the bottom wall of the case 21, and a plurality of arms 32 extended from the bearing unit. The arms 32 are positioned in parallel to the surfaces of the magnetic disks 16, and at a predetermined spacing between each other, and extend in the same direction from the bearing unit 26. The carriage assembly 22 is also provided with a long and narrow plate-like suspension 38, which can be elastically deformed. The suspension 38 is formed of a leaf spring, its proximal end is fixed to the extended end of the arm 32 by spot welding or adhesive joining, and the suspension 38 extends from the arm. Each suspension 38 may be integrally formed with a corresponding arm 32.

As shown in FIG. 2, each magnetic head 40 has a substantially rectangular slider 42, and a magneto-resistive (MR) head portion 44 arranged in the slider to perform recording and reproduction, and it is fixed to a gimbal spring 41 provided at the distal end of the suspension 38. In addition, a load is applied to Each magnetic head 40 is applied with a load toward the magnetic disk from the suspension 38 through a dimple 43 formed in the suspension 38.

As shown in FIG. 1, the carriage assembly 22 has a support frame 45 extending from the bearing unit 26 in a direction opposite to the arm 32. The support frame 45 supports a voice coil 47 constituting a part of the VCM 24. The support frame 45 is made of a synthetic resin, and integrally formed on the outer periphery of the voice coil 47. The voice coil 47 is positioned between a pair of yokes 49 fixed to the case 12, and constitutes the VCM 24 in association with these yokes and a magnet (not shown) fixed to one of the yokes. By supplying power to the voice coil 47, the carriage assembly 22 is rotated around the bearing unit 26, and the magnetic head 40 is moved to and positioned above a desired track of the magnetic disk 16.

The ramped loading mechanism 25 comprises a ramp 51 arranged on the bottom wall of the case 12 and outside the magnetic disk 16, and a tab 53 extending from the distal end of each suspension 38. When the carriage assembly 22 is rotated to a retreating position outside the magnetic disks 16, each tab 53 is engaged with a ramp surface formed in the ramp 51, and then pulled up by inclination of the ramp surface to unload the magnetic head.

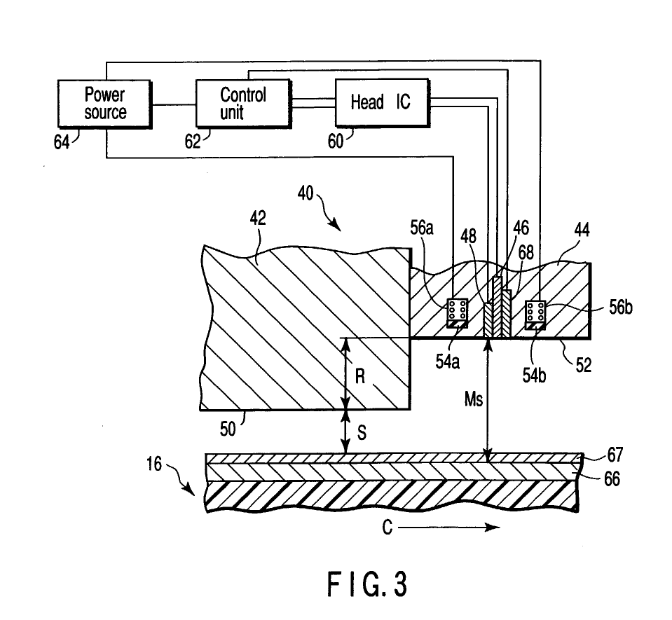

Next, detailed description will be given of a constitution of the magnetic head 40. As shown in FIGS. 2 and 3, the magnetic head 40 includes the slider 42 made of a mixture of alumina and titanium carbide, and the head portion 44 made of alumina. In the head portion 44, recording and reproducing elements 46 and 48 made of titanium, iron, aluminum or the like are formed by a semiconductor technology.

The slider 42 is formed in the shape of a substantially square column, and has a nearly flat disk opposing surface 50 opposite to the surface of the magnetic disk 16. Similarly, the head portion 44 has a nearly flat disk opposing surface 52 opposite to the surface of the magnetic disk 16. The disk opposing surface 52 is positioned more apart from the surface of the magnetic disk than the disk opposing surface 50 of the slider 42, and formed keeping up a level difference R. The level difference R is set to, for example about 5 nm.

In the head portion 44, the recording and reproducing elements 46 and 48 are disposed to be adjacent to each other and in a condition such that their ends are exposed to the disk opposing surface 52. The recording and reproducing elements 46 and 48 are connected to a head IC 60 and a control unit 62 through wirings disposed in the carriage assembly 22. A write signal is sent through the control unit 62 and the head IC 60 to the recording element 46, and a read output from the reproducing element 48 is sent through the head IC to the control unit 62.

In the head portion 44, a temperature detector 68 is disposed in the vicinity of the recording element 46. The temperature detector 68 detects the temperature in the vicinity of the reproducing and recording elements 48 and 46, and inputs the detected temperature to the control unit 62.

In the head portion 44, first and second thermal expanding members 54a, 54b, and first and second heat generating coils 56a, 56b for respectively heating the thermal expanding members are disposed. The first and second thermal expanding members 54a, 54b are disposed on upstream and downstream sides of the recording and reproducing elements 46 and 48 with respect to a rotational direction C of the magnetic disk 16. The first and second thermal expanding members 54a, 54b are disposed slightly away from the disk opposing surface 52, and formed to thermally expand in the direction of approaching the surface of the magnetic disk 16. The first and second thermal expanding members 54a, 54b are formed of, for example resist layers used to form the head portion 44.

The first and second heat generating coils 56a, 56b that function as heating elements are disposed to be respectively adjacent to the first and second thermal expanding members 54a, 54b on the side opposite to the disk opposing surface 52. The first and second heat generating coils 56a, 56b are electrically connected through the wirings disposed in the carriage assembly 22 to a power source 64 and the control unit 62. Current is supplied from the power source 64 to the first and second heat generating coils 56a, 56b under control by the control unit 62.

As described later, the control unit 62 constitutes a space detecting unit, a space control unit, a power supplying control unit, and a converting unit.

A magnetic recording layer 66 and a protective film layer 67 are laminated on the surface of the magnetic disk 16. In the floating type magnetic head, the slider 42 always floats by maintaining a space S between the surface of the rotating magnetic disk 16 and the disk opposing surface 50. In the contact type magnetic head, the space S between the slider 42 and the surface of the magnetic disk becomes Zero. A space between the reproducing element 48 and the magnetic recording layer 66 becomes magnetic spacing Ms.

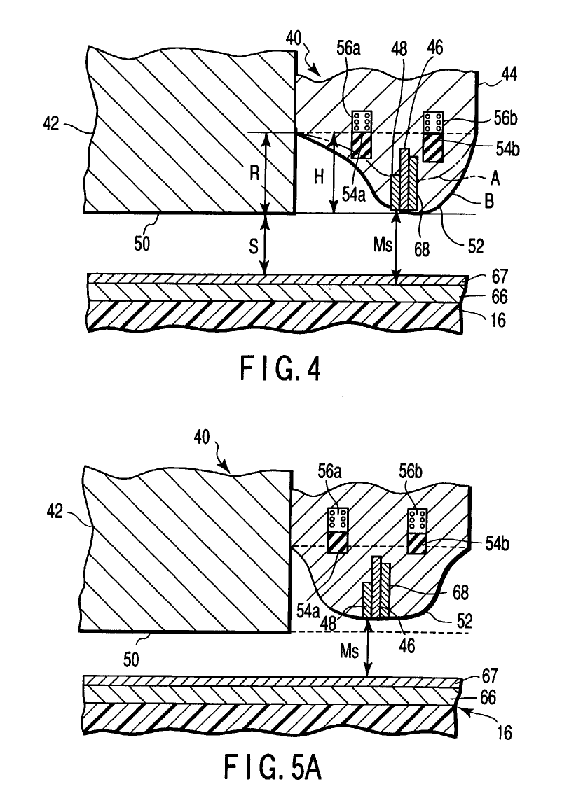

In the HDD constructed in the foregoing manner, the head portion 44 of the magnetic head 40 expands by an increase in ambient temperature, or heat generated from the recording element 46 during a recording operation, to project the disk opposing surface 52 toward the magnetic disk 16. FIG. 4 shows the magnetic head 40 when maximum projection occurs under operating conditions of the HDD. Here, the maximum projection is represented by the sum of projection A in the vicinity of the recording element part at a specified upper temperature limit, and projection B in the vicinity of the recording element part following a temperature increase during signal recording.

If the maximum projection following a temperature increase is H, in the contact type magnetic head, by setting the level difference R between the slider 42 and the head portion 44 to R>H, the head portion 44 is always prevented from being brought into contact with the surface of the magnetic disk 16 in its projected state. In the floating type magnetic head, by space detection as described later, it is only necessary to set the level difference R equal to or lower than the space between the reproducing element 48 and the magnetic recording layer 66.

If the level difference R is set as described above, projection of the head portion 44 becomes only projection by ambient temperature during information reading, i.e., information reproduction. Consequently, magnetic spacing Ms becomes excessively large and the reproducing output from the reproducing element 48 reduces. Also during signal recording, depending on the conditions of recording current and ambient temperature, there is room for a further reduction of magnetic spacing Ms.

Thus, according to the embodiment, at the time of starting information reproducing and recording operations in the magnetic disk 16, power is supplied to the first and second heat generating coils 56a, 56b disposed in the head portion 44 to selectively expand the first and second thermal expanding members 54a, 54b, thereby adjusting the projection amount of the disk opposing surface 52 of the head portion. As the result, the magnetic spacing Ms can be adjusted to an optimal value, e.g., 12 to 15 nm.

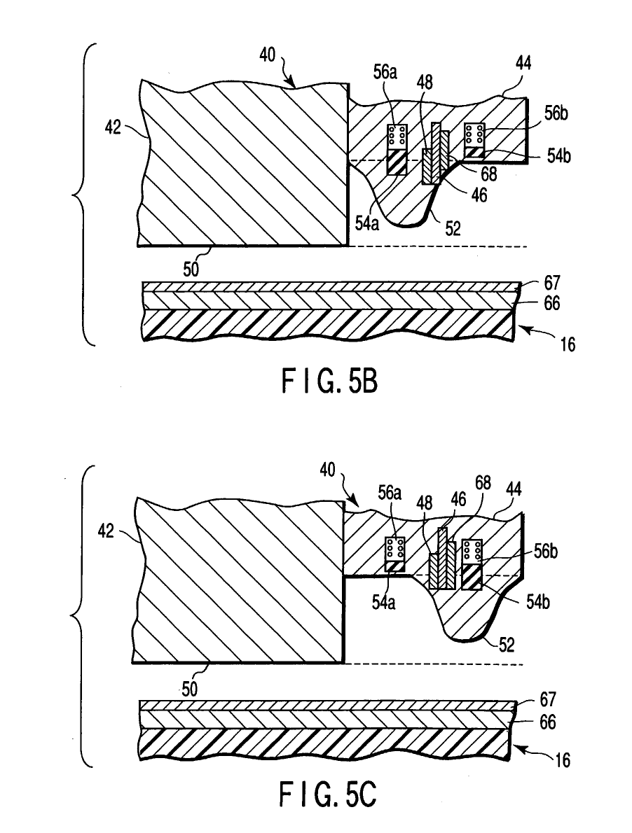

FIG. 5A shows a state where power is simultaneously supplied to the first and second heat generating coils 56a, 56b to expand the first and second thermal expanding members 54a, 54b, and the disk opposing surface 52 of the head portion 44 is projected. The projection of the disk opposing surface 52 is equivalent to the sum of projection of the disk opposing surface 52 obtained by supplying power only to the first heat generating coil 56a shown in FIG. 5B, and projection of the disk opposing surface 52 obtained by supplying power only to the second heat generating coil 56b shown in FIG. 5C.

Adjustment of the projection amount of the disk opposing surface 52, i.e., adjustment of the magnetic spacing Ms, is carried out by the following operation. Before starting information recording or reproduction with respect to the magnetic disk 16, a temperature in the vicinity of the reproducing and recording elements 48 and 46 is detected by the temperature detector 68, and the detection result is input to the control unit 62. The control unit 62 stores a relation between the projection amount of the disk opposing surface 52 following expansion of the first and second thermal expanding members 54a, 54b measured beforehand during information reproducing and amounts of power supplied to the first and second heat generating coils 56a, 56b, and a relation between the amounts of power supplied to the first and second heat generating coils 56a, 56b and the temperature in the vicinity of the temperature detector 68. Based on these relations, the control unit 62 converts the input temperature into a projection amount of the disk opposing surface 52 following the expansion of the first and second thermal expanding members 54a, 54b, i.e., magnetic spacing Ms, and compares it with a preset reference level.

Then, if the magnetic spacing Ms obtained by the conversion of the temperature information is larger than the reference level, the control unit 62 supplies power from the power source 64 to the first and second heat generating coils 56a, 56b to generate heat, thereby expanding the first and second thermal expanding members 54a, 54b. Accordingly, the disk opposing surface 52 of the head portion 44 projects toward of the magnetic disk surface to reduce the magnetic spacing Ms.

Conversely, if the magnetic spacing obtained by the conversion of the temperature information is smaller than the reference level, the control unit 62 reduces the amounts of power supplied from the power source 64 to the first and second heat generating coils 56a, 56b to lower the amount of generated heat, thereby reducing the amount of expansion of the first and second thermal expanding members 54a, 54b. Accordingly, the projection amount of the disk opposing surface 52 of the head portion 44 is reduced to increase the magnetic spacing Ms.

As described above, the control unit 62 adjusts the amounts of power supplied to the first and second heat generating coils 56a, 56b to control the expansion of the first and second thermal expanding members 54a, 54b, thereby making the magnetic spacing obtained by the conversion of the temperature information coincide with the reference level, in other words, setting the magnetic spacing Ms to an optimal value. After the magnetic spacing Ms of the magnetic head 40 is adjusted to the optimal value, desired recording and reproducing operations are carried out with respect to the magnetic disk 16.

During the information recording operation, the recording element 46 generates heat to increase the projection amount of the disk opposing surface 52. Therefore, by using the relation between the projection amount of the disk opposing surface 52 following the expansion of the first and second thermal expanding members 54a, 54b measured beforehand during the information recording and the amounts of power supplied to the first and second heat generating coils 56a, 56b, and the relation between the amounts of power supplied to the first and second heat generating coils 56a, 56b and the temperature in the vicinity of the temperature detector 68, the amounts of power supplied to the heat generating coils 56a, 56b are controlled to maintain the magnetic spacing Ms at the optimal value.

According to the embodiment, the temperature detector 68 is arranged in the vicinity of the reproducing and recording elements 48 and 46 to detect the temperature. However, if the relation between the temperature detected by the temperature detector and stored in the control unit 62 and the magnetic spacing Ms of the magnetic head 40 can be mutually changed, the temperature detector 68 can be arranged at the positions other than the vicinity of the reproducing and recording elements 48 and 46.

The adjustment of the projection amount of the disk opposing surface 52, i.e., the adjustment of the magnetic spacing Ms, may be carried out in the following manner. Before starting information recording or reproduction, the control unit 62 supplies power of a given value to the first and second heat generating coils 56a, 56b. Then, the control unit 62 detects whether reproducing signals read by the reproducing element 48 includes or not any abnormal signals (thermal asperities) due to contact between the magnetic head 40 and the magnetic disk 16.

Here, if an abnormal signal is detected, the control unit 62 determines the contact between the magnetic head 40 and the magnetic disk 16 and reduces the power of given value supplied to the first and second heat generating coils 56a, 56b. Accordingly, the expansion of the first and second thermal expanding members 54a, 54b are reduced to increase the space between the magnetic head 40 and the magnetic disk 16. Conversely, if no abnormal signals are detected, the control unit 62 increases the power of given value supplied to the first and second heat generating coils 56a, 56b. Accordingly, the expansion of the first and second thermal expanding members 54a, 54b are increased to reduce the space between the magnetic head 40 and the magnetic disk 16.

Thus, based on the contact detection information obtained by detecting the presence of abnormal reproducing signals, in order to set the magnetic spacing Ms to an optimal value, the control unit 62 adjusts the amounts of power supplied to the first and second heat generating coils 56a, 56b to control the expansion of the first and second thermal expanding members 54a, 54b. After the magnetic spacing Ms of the magnetic head 40 is adjusted to the optimal value as described above, desired recording and reproducing operations are carried out on the magnetic disk 16.

Further, the adjustment of the projection amount of the disk opposing surface 52, i.e., the adjustment of the magnetic spacing Ms, can be carried out in the following manner. That is, before starting information recording or reproduction with respect to the magnetic disk 16, information is read from the recording layer 66 of the magnetic disk 16 by the reproducing element 48, and its reproducing signal is input to the control unit 62. Then, the control unit 62 compares an output level of the input reproducing signal with a preset reference level.

Here, the output level of the reproducing signal has a correlation with the magnetic spacing Ms. The output level is large when the magnetic spacing Ms is small. Conversely, the output level is small when the magnetic spacing Ms is large. Accordingly, the control unit 62 can detect the magnetic spacing Ms based on the output level of the reproducing signal. Then, the control unit 62 compares the output level of the reproducing signal with the reference level. If the output level is lower than the reference level, the control unit 62 supplies power from the power source 64 to the first and second heat generating coils 56a, 56b to generate heat, thereby expanding the first and second thermal expanding members 54a, 54b. Accordingly, the disk opposing surface 52 of the head portion 44 projects toward the surface of the magnetic disk to reduce the magnetic spacing Ms.

Conversely, if the output level of the reproducing signal is higher than the reference level, the control unit 62 reduces the amounts of power supplied from the power source 64 to the first and second heat generating coils 56a, 56b to lower the amounts of generated heat, thereby reducing the expansion of the first and second thermal expanding members 54a, 54b. Accordingly, the projection amount of the disk opposing surface 52 is reduced to increase the magnetic spacing Ms.

Thus, in order to make the output level of the reproducing signal coincide with the reference level, in other words, in order to set the magnetic spacing Ms to an optimal value, the control unit 62 adjusts amounts of power supplied to the first and second heat generating coils 56a, 56b to control the amounts of generated heat of the first and second heat generating coils and the expansion of the first and second thermal expanding members. After the magnetic spacing Ms of the magnetic head 40 is adjusted to the optimal value as described above, desired recording and reproducing operations are carried out on the magnetic disk 16. During the information recording operation, the recording element 48 generates heat to increase the projection amount of the disk opposing surface 52. Therefore, the control unit 62 controls the amounts of power supplied to the first and second heat generating coils 56a, 56b in accordance with the output level of the reproducing element 48 to maintain the magnetic spacing Ms at the optimal value.

As described above, according to the magnetic head of the foregoing constitution and the HDD provided with the same, by supplying power to the first and second heat generating coils 56a, 56b disposed on the outlet and inlet sides of the recording, reproducing elements 46 and 48 to generate heat, thereby thermally expanding the first and second thermal expanding members 54a, 54b, the magnetic spacing Ms can be controlled to the optimal value. Thus, while adjusting the magnetic spacing Ms to a minimum within a range of the level difference R between the disk opposing surface 50 of the slider 42 and the disk opposing surface 52 of the head portion 44, generation of abnormal signals or uneven wear caused by contact between the magnetic head and the surface of the magnetic disk can be suppressed. Therefore, it is possible to highly accurately record and reproduce information to/from the magnetic disk.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

For example, according to the embodiment, the constitution is adopted where the first and second thermal expanding members are both thermally expanded simultaneously to adjust the magnetic spacing. However, one of the thermal expanding members may be selectively expanded to adjust the magnetic spacing. Also, the adjustment of the magnetic spacing may be carried out only during information reproduction. Moreover, the numbers of the thermal expanding members and the heat generating coils are not limited to two respectively. The numbers may be one or three in accordance with the structure of the head portion 44, the type of thermal expansion, or the like. The heating elements are not limited to the heat generating coils, and electric heat converting elements or the like can be used.

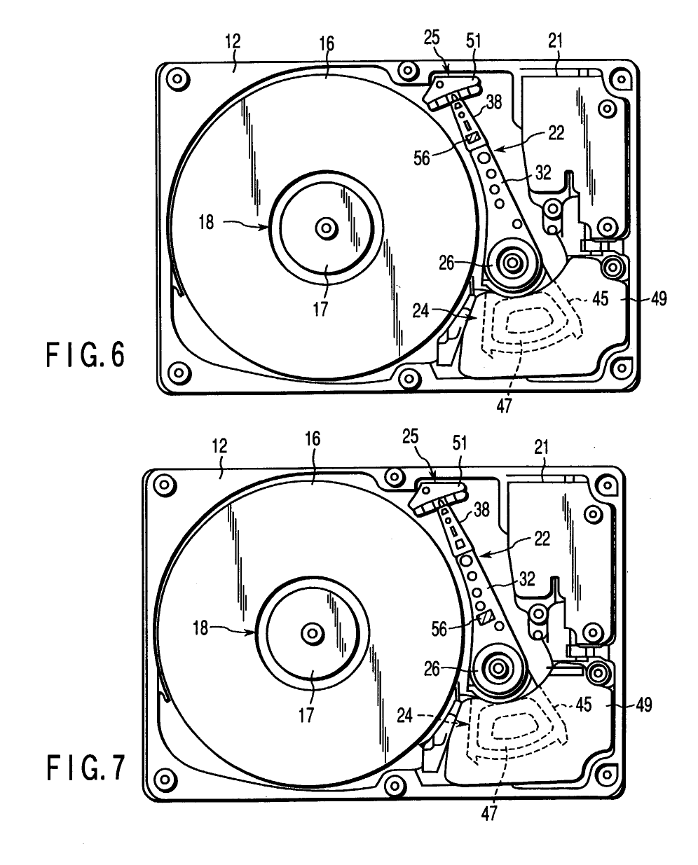

On the other hand, according to the embodiment, the constitution is adopted where the heating element is incorporated in the head portion. However, the heating element 56 may be disposed on the suspension 38 as shown in FIG. 6, or on the arm 32 as shown in FIG. 7. Further, the heating element 56 may be disposed in another part on the carriage assembly 22.

Furthermore, the embodiment has been described by way of each of the constitutions where the projection amount of the head portion is adjusted based on the temperature in the vicinity of the reproducing and recording elements of the magnetic head, based on the presence of abnormal reproducing signals, and based on the output level of the reproducing signal. However, a constitution may be adopted where the projection amount of the head portion is adjusted by combining two or all of the above-described constitutions.

What is claimed is:

1. A magnetic disk apparatus comprising:
a magnetic disk having a magnetic recording layer;
a magnetic head including a slider having a disk opposing surface opposite to a surface of the magnetic disk, and a head portion arranged on the slider, the head portion having a disk opposing surface positioned more apart from the surface of the magnetic disk than the disk opposing surface of the slider, recording and reproducing elements at least partially exposing to the disk opposing surface and configured to record and reproduce information on and from the magnetic recording layer of the magnetic disk, and a thermal expanding member arranged in the vicinity of the recording and reproducing elements and configured to thermally expand the disk opposing surface in a direction of approaching the surface of the magnetic disk;
a heating element which heats the thermal expanding member;
a space detecting unit configured to detect a space between the disk opposing surface of the magnetic head and the surface of the magnetic disk; and
a space control unit which adjusts an amount of heat generated from the heating element in accordance with the space detected by the space detecting unit to control the space between the disk opposing surface of the magnetic head and the surface of the magnetic disk to a desired value.

2. The magnetic disk apparatus according to claim 1, wherein the heating element is arranged in the head portion at a position adjacent to the thermal expanding member.

3. The magnetic disk apparatus according to claim 2, wherein the heating element has a heat generating coil, and the space control unit includes a power source configured to supply current to the heat generating coil, and a power supplying control unit which adjusts an amount of power supplied to the heat generating coil.

4. The magnetic disk apparatus according to claim 1, further comprising a carriage assembly supporting the magnetic head to be movably with respect to the disk,
wherein the carriage assembly includes an arm, and a suspension extending from the arm, the magnetic head is supported on an extending end of the suspension, and the heating element is provided on the carriage assembly.

5. The magnetic disk apparatus according to claim 4, wherein the heating element has a heat generating coil, and the space control unit includes a power source configured to supply current to the heat generating coil, and a power supplying control unit which adjusts an amount of power supplied to the heat generating coil.

6. The magnetic disk apparatus according to claim 5, wherein the space detection unit is configured to the space between the magnetic head and the surface of the magnetic disk based on strength of reproducing signals read by the reproducing element, and the space control unit includes a power supplying control unit which adjusts an amount of power supplied to the heat generating coil in accordance with the space detected by the space detection unit.

7. A magnetic disk apparatus comprising:
a magnetic disk having a magnetic recording layer;
a magnetic head including a slider having a disk opposing surface opposite to a surface of the magnetic disk, and a head portion arranged on the slider, the head portion having a disk opposing surface positioned more apart from the surface of the magnetic disk than the disk opposing surface of the slider, recording and reproducing elements at least partially exposing to the disk opposing surface and configured to record and reproduce information on and from the magnetic recording layer of the magnetic disk, and a thermal expanding member arranged in the vicinity of the recording and reproducing elements and configured to thermally expand the disk opposing surface in a direction of approaching the surface of the magnetic disk;
a heating element which heats the thermal expanding member; and
a space control unit which adjusts an amount of heat generated from the heating element in accordance with a temperature in the vicinity of the magnetic head to control the space between the disk opposing surface of the magnetic head and the surface of the magnetic disk to a desired value.

8. The magnetic disk apparatus according to claim 7, wherein the heating element is arranged in the head portion at a position adjacent to the thermal expanding member.

9. The magnetic disk apparatus according to claim 8, wherein the heating element has a heat generating coil, and the space control unit includes a power source configured to supply current to the heat generating coil, and a power supplying control unit which adjusts an amount of power supplied to the heat generating coil.

10. The magnetic disk apparatus according to claim 7, further comprising a carriage assembly supporting the magnetic head to be movably with respect to the disk,
wherein the carriage assembly includes an arm, and a suspension extending from the arm, the magnetic head is supported on an extending end of the suspension, and the heating element is provided on the carriage assembly.

11. The magnetic disk apparatus according to claim 10, wherein the heating element has a heat generating coil, and the space control unit includes a power source configured to supply current to the heat generating coil, and a power supplying control unit which adjusts an amount of power supplied to the heat generating coil.

12. The magnetic disk apparatus according to claim 11, wherein the space control unit includes a temperature detector provided at one of the magnetic head and the carriage assembly, a converting unit which converts information of a temperature detected by the temperature detector into information of the space between the disk opposing surface of the magnetic head and the surface of the magnetic disk, and a power supplying control unit configured to adjust an amount of power supplied to the heat generating coil in accordance with the conversion information.

13. A magnetic disk apparatus comprising:
a magnetic disk having a magnetic recording layer;
a magnetic head including a slider having a disk opposing surface opposite to a surface of the magnetic disk, and a head portion arranged on the slider, the head portion having a disk opposing surface positioned more apart from the surface of the magnetic disk than the disk opposing surface of the slider, recording and reproducing elements at least partially exposing to the disk opposing surface and configured to record and reproduce information on and from the magnetic recording layer of the magnetic disk, and a thermal expanding member arranged in the vicinity of the recording and reproducing elements and configured to thermally expand the disk opposing surface in a direction of approaching the surface of the magnetic disk;
a heating element which heats the thermal expanding member; and
a space control unit which adjusts an amount of heat generated from the heating element in accordance with contact detection information concerning contact between the magnetic head and the magnetic disk to control a space between the disk opposing surface of the magnetic head and the surface of the magnetic disk to a desired value.

14. The magnetic disk apparatus according to claim 13, wherein the heating element is arranged in the head portion at a position adjacent to the thermal expanding member.

15. The magnetic disk apparatus according to claim 14, wherein the heating element has a heat generating coil, and the space control unit includes a power source configured to supply current to the heat generating coil, and a power supplying control unit which adjusts an amount of power supplied to the heat generating coil.

16. The magnetic disk apparatus according to claim 13, further comprising a carriage assembly supporting the magnetic head to be movably with respect to the disk, and wherein the carriage assembly includes an arm, and a suspension extending from the arm, the magnetic head is supported on an extending end of the suspension, and the heating element is provided on the carriage assembly.

17. The magnetic disk apparatus according to claim 16, wherein the heating element has a heat generating coil, and the space control unit includes a power source configured to supply current to the heat generating coil, and a power supplying control unit which adjusts an amount of power supplied to the heat generating coil.

18. The magnetic disk apparatus according to claim 17, wherein the space control unit includes a contact detecting unit configured to determine an abnormal signal caused by contact between the magnetic head and the magnetic disk among reproducing signals read by the reproducing element, and a power supplying control unit configured to adjust an amount of power supplied to the heat generating coil in accordance with the determination result of the contact detecting unit.
